(19) United States
(12) Patent Application Publication
(10) Pub. No.: US 2007/0135997 A1
(43) Pub. Date: Jun. 14, 2007

(54) Methods for analysis of biological dataset profiles

(76) Inventor: Evangelos Hytopoulos, San Mateo, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/553,818

(22) PCT Filed: Apr. 23, 2004
(86) PCT No.: PCT/US04/12688

§ 371 Date: Feb. 8, 2007

Related U.S. Application Data
(60) Provisional application No. 60/465,152, filed on Apr. 23, 2003.
(60) Provisional application No. 60/539,447, filed on Jan. 26, 2004.

(51) Int. Cl. G06G 7/48; G06F 19/00

(52) U.S. Cl. 702/19; 703/11

(57) ABSTRACT

Methods are provided for evaluating biological dataset profiles, where datasets comprising information for multiple cellular parameters are compared and identified. A typical dataset comprises readouts from multiple cellular parameters resulting from exposure of cells to biological factors in the absence or presence of a candidate agent. For analysis of multiple context-defined systems, the output data from multiple systems may be concatenated.

### FIELD OF THE INVENTION

The present invention relates to the analysis of cellular pathways pathways, and more particularly to methods and algorithms for identifying the pathways in which a particular agent acts, allowing the identification of mechanisms of drug action and gene function. Interactions between pathways and functional relationships of components within pathways can be identified. Software and methods for evaluating correlations between biological datasets are provided.

### BACKGROUND OF THE INVENTION

Knowledge of the biochemical pathways by which cells detect and respond to stimuli is important for the discovery, development, and correct application of pharmaceutical products. Cellular physiology involves multiple pathways, which have complex relationships. For example, pathways split and join; there are redundancies in performing specific actions; and response to a change in one pathway can modify the activity of another pathway. In order to understand how a candidate agent is acting and whether it will have the desired effect, the end result, and effect on pathways of interest is as important as knowing the target protein.

Methods for determining the pathways affected by an agent or genotype modification in a cell, and for identifying common modes of operation between agents and genotype modifications, are described in International Patent application W001/067103. Cells capable of responding to factors, simulating a state of interest are employed. Preferably the cells are primary cells in biologically relevant contexts. A sufficient number of factors are employed to involve a plurality of pathways and a sufficient number of parameters are selected to provide an informative dataset. The data resulting from the assays can be processed to provide robust comparisons between different environments and agents.

The application of statistical methods to the analysis of complex datasets can provide a means to determine correlations and identities, or the lack thereof. Logistic models can be combined with discriminant analysis to consider the interactions among the dataset parameters, and to provide statistical models that are effective in determining identity among datasets.

There is an ongoing need in the art to generate better and more useful ways for statistical analysis of the large volume of biological response data generated by compound and genetic screening. Methods providing statistically meaningful models for such screening methods provide a means of addressing this issue.

### SUMMARY OF THE INVENTION

The present invention provides methods, software, and systems for evaluating biological dataset profiles, where datasets comprising information for multiple cellular parameters are compared and identified. In a preferred embodiment of the invention, the dataset is a BioMAP® dataset. A typical dataset comprises readouts from multiple cellular parameters resulting from exposure of cells to biological factors in the absence or presence of a candidate agent, where the agent may be a genetic agent, e.g. expressed coding sequence; or a chemical agent, e.g. drug candidate. Datasets may be control datasets, or test datasets, or profile datasets that reflect the parameter changes of known agents. For analysis of multiple context-defined systems, the output data from multiple systems may be concatenated.

In one embodiment of the invention, a prediction envelope is generated for a control dataset, which prediction envelope provides upper and lower limits for experimental variation in parameter values. The prediction envelope(s) may be stored in a computer database for retrieval by a user, e.g. in a comparison with a test dataset.

In another embodiment of the invention, the prediction envelope for a control dataset provides the basis for determining whether a test dataset is different from a control or profile dataset, with a predefined level of statistical significance.

In another embodiment of the invention, a database of trusted profile datasets is established. To obtain a trusted profile for an agent X, repeats of profiles from N experiments are averaged. Repeats of the profile for agent X that have not been averaged are classified, and the classification error plotted as a function of the number of profiles used to obtain the average. This establishes the number of repeats required to minimize the misclassification error. Trusted profiles are generated by averaging a number of repeats sufficient to minimize misclassification error. The database of trusted profile is typically stored in a computer for retrieval by a user, provides a basis for identification of test profiles.

### BRIEF DESCRIPTION OF THE DRAWINGS

FIG. 1: Control envelope at 92% prediction envelope obtained without control data centering.

FIG. 2: Control envelope at 92% prediction level with control data centering

FIG. 3: Testing BioMAP gene over-expression profiles for significance. Profile x1241 is significant at 95% significance level.

FIG. 4: Misclassification error as a function of experimental and well repeats. Clearly, three experimental repeats are sufficient for error minimization.

FIG. 5: Searching “trusted” profiles with the profile for Flurbiprofen. Top five candidates are different concentrations of the agents: Flurbiprofen, Budenoside, FR122047, all prostagladin inhibitors.

FIG. 6: Pairwise correlation coefficient (Pearson) for a set of compounds

FIG. 7: Pairwise correlation coefficient (Pearson) for a set of compounds after thresholding and clustering using MDS/pivoting.

FIG. 8: Pairwise correlation coefficient for gene over-expression profiles after thresholding for significance and clustering (MDS/pivoting).

FIG. 9a: Network representation of compound set tested in HuVEC-PBMC system. The network is obtained by applying MDS on the correlation matrix of FIG. 6, in 2 dimensions. FIG. 9b: Two dimensional network of genes that are members of 4 pathways. The network is obtained by applying 2D MDS to the pairwise correlation coefficients of FIG. 8. FIG. 9c: Three dimensional network of genes that are members of 4 pathways. The network is obtained by applying 3D MDS to the pairwise correlation coefficients of FIG. 8.

FIG. 10. Response profiles induced in endothelial cells over-expressing selected genes and stimulated with pro-inflammatory cytokines. Endothelial cells transduced with retroviral vectors expressing the genes TNFRSF1A, MYD88 and RAS* were treated with IL-1β, TNF-α, IFNγ or media alone (Control). The relative levels of readout parameters (CD31, E-selectin etc.) were measured by ELISA. Data presented are log expression ratios (see Methods) from three (TNFRSF1A, RAS*) or four (MYD88) repeat experiments. The black line representing the overall shape of each profile connects the mean values of the data points.

FIG. 11. Functional classification of genes in multiple cellular contexts. (a) Endothelial cells transduced with retroviral vectors expressing the genes listed to the right were treated with IL-1β, TNF-α, IFN-γ or media alone (Control). Figure shows relative increase (red), decrease (green) or lack of change (black) in the mean log expression ratio of each parameter relative to non-transduced cells in two to four experiments. (b) Pairwise Pearson correlation analysis of gene-specific profiles using the combined 28 parameter profile comprising all seven readouts from each of the four cellular systems (cells+cytokine-defined contexts) combined into a single datastring for calculations. Positive correlation is shown in blue and negative correlation in yellow. The order of genes in the figure was automatically determined by multidimensional scaling of the Pearson correlation metric (see Methods). (c-d) Two-dimensional representations of the functional similarity of gene profiles revealed in each individual system (cells in medium alone (c); IL-1β-treated cells (d); TNF-α-treated cells (e); and IFN-γ-treated cells (f). Pearson correlation analysis was performed as before, using the seven readouts within a given system, and multidimensional scaling was used to represent the extent of similarity of gene activities in the systems indicated. Only genes whose responses showed significant similarity to other genes in the indicated system are shown. In (g), the relationships revealed by combined systems analysis are shown. In this case, the 28 parameter combined systems profiles (encompassing the 7 readouts from each of the 4 cell systems) was used for correlation analysis and 2 dimensional representation. The arrangement of genes in two dimensions was automatically determined by multidimensional scaling (see Methods), and statistically significant correlations are shown by the connecting lines. Genes are color-coded to indicate participation in common pathways (red: NF-κB; blue: RAS/MAPK; green: IFN-γ; grey PI3K/Akt: and white: novel genes).

FIG. 12. IL-1 activates the RAS/MAPK pathway through MYD88, stimulating a MAPK-dependent negative feedback loop modulating endothelial VCAM-1 expression. (a) Endothelial cells over-expressing MYD88, RAS*, MEK1* or MEK2* were stimulated with IL-1β, TNF-α or media alone (None), and VCAM-1 expression was measured by ELISA. MEK inhibitor PD098059 (3.7 μM) or DMSO (0.1%) as buffer control were added to cells one hour prior to cytokine stimulation. Note that blockade of the RAS/MAPK pathway with PD098059 increases VCAM-1 expression when the pathway is activated through RAS*, MEK1*, MEK2* or IL-1/MYD88, but not in cells treated with TNF. Error bars indicate standard deviation from triplicate samples. (b) Endothelial cells were stimulated with TNF-α (10 ng/ml), IL-1β (1 ng/ml) or a mixture of TNF and IL-1 (10 ng/ml TNF+1 ng/ml IL-1), and VCAM-1 expression was measured by ELISA. Note that IL-1 modulates the VCAM-1 expression induced by TNF. (c) Endothelial cells were co-transduced with RAS*+empty vector, RAS*+IKBKB* or RAS*+RELA. Expression of individual genes in co-transduced cells was confirmed by quantitative RT−PCR. Cells transduced with RAS*+empty vector were treated with IL-1β to stimulate the NF-κB pathway. In cells transduced with RAS*+IKBKB* or RAS*+RELA cells the NF-κB pathway is stimulated by over-expression of IKBKB* and RELA themselves. Note that RAS* has no effect on VCAM expression in cells expressing IKBKB* or RELA. (d) Schematic diagram of the interactions between the NF-κB and RAS/MAPK pathways in endothelial cells. Genes are color coded according to the pathways to which they belong (red: NF-κB; blue: RAS/MAPK). The split coloration of MYD88 and IRAK1 genes indicates that they participate in both pathways. Red dotted lines represent novel pathway interactions revealed by the present study.

FIGS. 13A and 13B depicts a graphic of a network model, where multiple views can be presented in three dimensions, and where each window may have the model representing different information. In FIG. 13A the color indicates the compound identification number, and size indicates the test concentration. In FIG. 13B the size indicates an effect on VCAM expression.

FIG. 14 depicts a graphic of a network model where the information about the compound class is conveyed by the color.

FIGS. 15A-15E depict a graphic of a network model, with using neighborhood filtering. In 15A the view is shown without neighborhood filtering. 15B-15E show the change in view. Initially the far cluster is not visible, looking in the neighborhood of the gray-blue cluster, but in approaching the former, the color changes and it is brought into view.

### DETAILED DESCRIPTION OF THE EMBODIMENTS

Biological datasets are analyzed to determine statistically significant matches between datasets, usually between test datasets and control, or profile datasets. Comparisons may be made between two or more datasets, where a typical dataset comprises readouts from multiple cellular parameters resulting from exposure of cells to biological factors in the absence or presence of a candidate agent, where the agent may be a genetic agent, e.g. expressed coding sequence; or a chemical agent, e.g. drug candidate.

A prediction envelope is generated from the repeats of the control profiles; which prediction envelope provides upper and lower limits for experimental variation in parameter values. The prediction envelope(s) may be stored in a computer database for retrieval by a user, e.g. in a comparison with a test dataset.

Using multidimensional scaling methods, relationships between components, e.g. proteins in a biological pathway; relationships between pathways; etc., are graphically displayed, to aid in the identification of such relationships.

In one embodiment of the invention, the analysis methods provided herein are used in the determination of functional homology between two agents. As used herein, the term “functional homology” refers to determination of a similarity of function between two candidate agents, e.g. where the agents act on the same target protein, or affect the same pathway. Functional homology may also distinguish compounds by the effect on secondary pathways, i.e. side effects. In this manner, compounds or genes that are structurally dissimilar may be related with respect to their physiological function. Parallel analyses allow identification of compounds with statistically similar functions across systems tested, demonstrating related pathway or molecular targets. Multi-system analysis can also reveal similarity of functional responses induced by mechanistically distinct drugs.

In a preferred embodiment, the datasets of information are obtained from biologically multiplexed activity profiling (BioMAP®), which methods are described, for example, in U.S. Pat. No. 6,656,695; in co-pending U.S. provisional patent application 60/465,152, filed Apr. 23, 2003; and U.S. patent applications U.S. Ser. No. 09/952,744, filed Sep. 13, 2001; U.S. Ser. No. 10/220,999; and U.S. Ser. No. 10/236,558, filed Sep. 5, 2002, herein each specifically incorporated by reference. Briefly, the methods provide screening assays for biologically active agents, where the effect of altering the environment of cells in culture is assessed by monitoring multiple output parameters. The result is a dataset that can be analyzed for the effect of an agent on a signaling pathway, for determining the pathways in which an agent acts, for grouping agents that act in a common pathway, for identifying interactions between pathways, and for ordering components of pathways.

The data from a typical “system”, as used herein, provides a single cell type or cell types (where there are multiple cells present in a well) in an in vitro culture condition. Primary cells are preferred, to avoid potential artifacts introduced by cell lines. In a system, the culture conditions provide a common biologically relevant context. Each system comprises a control, e.g. the cells in the absence of the candidate biologically active agent. The samples in a system are preferably provided in triplicate, and may comprise one, two, three or more triplicate sets.

As used herein, the biological context refers to the exogenous factors added to the culture, which factors stimulate pathways in the cells. Numerous factors are known that induce pathways in responsive cells. By using a combination of factors to provoke a cellular response, one can investigate multiple individual cellular physiological pathways and simulate the physiological response to a change in environment.

A BioMAP® dataset comprises values obtained by measuring parameters or markers of the cells in a system. Each dataset will therefore comprise parameter output from a defined cell type(s) and biological context, and will include a system control. As described above, each sample, e.g. candidate agent, genetic construct, etc., will generally have triplicate data points; and may be multiple triplicate sets. Datasets from multiple systems may be concatenated to enhance sensitivity, as relationships in pathways are strongly context-dependent. It is found that concatenating multiple datasets by simultaneous analysis of 2, 3, 4 or more systems will provide for enhance sensitivity of the analysis.

By referring to a BioMAP®, or functional profile, it is intended that the dataset will comprise values of the levels of at least two sets of parameters, preferably at least three parameters, more preferably 4 parameters, and may comprise five, six or more parameters. Preferably, a small set of about 3 to 5 biologically relevant parameters is measured.

In many cases the literature has sufficient information to establish the system conditions to provide a useful functional profile. Where the information is not available, by using the procedures described in the literature for identifying markers for diseases, using subtraction libraries, microarrays for RNA transcription comparisons, proteomic or immunologic comparisons, between normal and cells in the physiologic state of interest, using knock-out and knock-in animal models, using model animals that simulate the physiological state, by introducing cells or tissue from one species into a different species that can accept the foreign cells or tissue, e.g. immunocompromised host, one can ascertain the endogenous factors associated with the physiologic state and the markers that are produced by the cells associated with the physiologic state.

The parameters may be optimized by obtaining a system dataset, and using pattern recognition algorithms and statistical analyses to compare and contrast different parameter sets. Parameters are selected that provide a dataset that discriminates between changes in the environment of the cell culture known to have different modes of action, i.e. the biomap is similar for agents with a common mode of action, and different for agents with a different mode of action. The optimization process allows the identification and selection of a minimal set of parameters, each of which provides a robust readout, and that together provide a biomap that enables discrimination of different modes of action of stimuli or agents. The iterative process focuses on optimizing the assay combinations and readout parameters to maximize efficiency and the number of signaling pathways and/or functionally different cell states produced in the assay configurations that can be identified and distinguished, while at the same time minimizing the number of parameters or assay combinations required for such discrimination.

Parameters are quantifiable components of cells. A parameter can be any cell component or cell product including cell surface determinant, receptor, protein or conformational or posttranslational modification thereof, lipid, carbohydrate, organic or inorganic molecule, nucleic acid, e.g. mRNA, DNA, etc. or a portion derived from such a cell component or combinations thereof. While most parameters will provide a quantitative readout, in some instances a semi-quantitative or qualitative result will be acceptable. Readouts may include a single determined value, or may include mean, median value or the variance, etc.

Markers are selected to serve as parameters based on the following criteria, where any parameter need not have all of the criteria: the parameter is modulated in the physiological condition that one is simulating with the assay combination; the parameter is modulated by a factor that is available and known to modulate the parameter in vitro analogous to the manner it is modulated in vivo; the parameter has a robust response that can be easily detected and differentiated; the parameter is secreted or is a surface membrane protein or other readily measurable component; the parameter desirably requires not more than two factors to be produced; the parameter is not co-regulated with another parameter, so as to be redundant in the information provided; and in some instances, changes in the parameter are indicative of toxicity leading to cell death. The set of parameters selected is sufficiently large to allow distinction between datasets, while sufficiently selective to fulfill computational requirements.

Parameters of interest include detection of cytoplasmic, cell surface or secreted biomolecules, frequently biopolymers, e.g. polypeptides, polysaccharides, polynucleotides, lipids, etc. Cell surface and secreted molecules are a preferred parameter type as these mediate cell communication and cell effector responses and can be more readily assayed. In one embodiment, parameters include specific epitopes. Epitopes are frequently identified using specific monoclonal antibodies or receptor probes. In some cases the molecular entities comprising the epitope are from two or more substances and comprise a defined structure; examples include combinatorially determined epitopes associated with heterodimeric integrins. A parameter may be detection of a specifically modified protein or oligosaccharide, e.g. a phosphorylated protein, such as a STAT transcriptional protein; or sulfated oligosaccharide, or such as the carbohydrate structure Sialyl Lewis x, a selectin ligand. The presence of the active conformation of a receptor may comprise one parameter while an inactive conformation of a receptor may comprise another, e.g. the active and inactive forms of heterodimeric integrin α_{M}β₂ or Mac-1.

Candidate biologically active agents may encompass numerous chemical classes, primarily organic molecules, which may include organometallic molecules, inorganic molecules, genetic sequences, etc. An important aspect of the invention is to evaluate candidate drugs, select therapeutic antibodies and protein-based therapeutics, with preferred biological response functions. Candidate agents comprise functional groups necessary for structural interaction with proteins, particularly hydrogen bonding, and typically include at least an amine, carbonyl, hydroxyl or carboxyl group, frequently at least two of the functional chemical groups. The candidate agents often comprise cyclical carbon or heterocyclic structures and/or aromatic or polyaromatic structures substituted with one or more of the above functional groups. Candidate agents are also found among biomolecules, including peptides, polynucleotides, saccharides, fatty acids, steroids, purines, pyrimidines, derivatives, structural analogs or combinations thereof.

Included are pharmacologically active drugs, genetic agents, etc. Compounds of interest include chemotherapeutic agents, anti-inflammatory agents, hormones or hormone antagonists, ion channel modifiers, and neuroactive agents. Exemplary of pharmaceutical agents suitable for this invention are those described in, “The Pharmacological Basis of Therapeutics,” Goodman and Gilman, McGraw-Hill, New York, N.Y., (1996), Ninth edition, under the sections: Drugs Acting at Synaptic and Neuroeffector Junctional Sites; Drugs Acting on the Central Nervous System; Autacoids: Drug Therapy of Inflammation; Water, Salts and Ions; Drugs Affecting Renal Function and Electrolyte Metabolism; Cardiovascular Drugs; Drugs Affecting Gastrointestinal Function; Drugs Affecting Uterine Motility; Chemotherapy of Parasitic Infections; Chemotherapy of Microbial Diseases; Chemotherapy of Neoplastic Diseases; Drugs Used for Immunosuppression; Drugs Acting on Blood-Forming organs; Hormones and Hormone Antagonists; Vitamins, Dermatology; and Toxicology, all incorporated herein by reference. Also included are toxins, and biological and chemical warfare agents, for example see Somani, S. M. (Ed.), “Chemical Warfare Agents,” Academic Press, New York, 1992).

The term “genetic agent” refers to polynucleotides and analogs thereof, which agents are tested in the screening assays of the invention by addition of the genetic agent to a cell. Genetic agents may be used as a factor, e.g. where the agent provides for expression of a factor. Genetic agents may also be screened, in a manner analogous to chemical agents. The introduction of the genetic agent results in an alteration of the total genetic composition of the cell. Genetic agents such as DNA can result in an experimentally introduced change in the genome of a cell, generally through the integration of the sequence into a chromosome. Genetic changes can also be transient, where the exogenous sequence is not integrated but is maintained as an episomal agents. Genetic agents, such as antisense oligonucleotides, can also affect the expression of proteins without changing the cell's genotype, by interfering with the transcription or translation of mRNA. The effect of a genetic agent is to increase or decrease expression of one or more gene products in the cell.

Agents are screened for biological activity by adding the agent to cells in the system; and may be added to cells in multiple systems. The change in parameter readout in response to the agent is measured to provide the BioMAP® dataset.

### Prediction Envelopes

In order to identify profiles that show an effect of the test agent (compound, gene, biologic and or combinations) in a system, a statistical test will provide a confidence level for a change in the parameters between the test and control profiles to be considered significant. A set of methods herein termed “control prediction envelope” are utilized. This set of methods uses the experimentally measured control profiles to create upper and lower limits for the level of variation of parameters values that one would expect in a subsequent experiment. These limits can be established at any level of statistical significance provided that enough experimental profiles are available.

The raw data may be initially analyzed by measuring the values for each parameter, usually in triplicate or in multiple triplicates. For each agent in a system, the mean value for each parameter is calculated; and divided by the mean parameter value from a negative control sample to generate a ratio. The ratios are then log₁₀ transformed. The transformed ratios may be averaged from repeat experiments of a system. The dataset thus obtained may be referred to as a normalized biomap dataset.

The “prediction envelope” methodology provides a non-parametric approach for establishing the significance of an agent profile. Methods of generating a prediction envelope may include a non-centered “prediction envelope”; centered “prediction envelope”; “centered prediction envelope” based on Hottling's T² method; and the like.

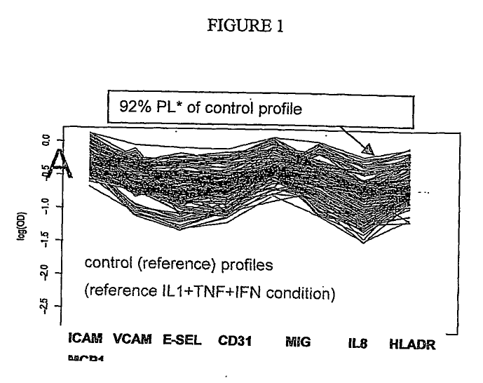

For a non-centered “prediction envelope” method, profiles that correspond to the control from many experiments are collected. These profiles contain a number of parameter values. The values that correspond to the measurement of each parameter can be the individual measurement from a well, the average of the replicates measured in the experiment, the median of the replicates, etc. FIG. 1 presents a set of such profiles that are composed from the values of eight readouts measured in experiments of HUVEC cells stimulated with IL-1/TNF/IFNγ. Visually, a 1-standard deviation envelope may be created around the profile of the combined means by connecting the points that correspond to the values of one standard deviation for each of the measured values for the parameters.

These two “envelope” lines are then moved parallel to themselves, by equal distances, outwards until a specific number of the control profiles are completely contained within them and a user specified number has at least one of the measured parameters outside them. The prediction level of the envelope is specified as the percentage of control curves that are completely contained within the “prediction envelope”. The method provides two important advantages: a) it does not a priori assume any statistical distribution of the experimental values and b) the method is able to self-adjust as more experimental data become available.

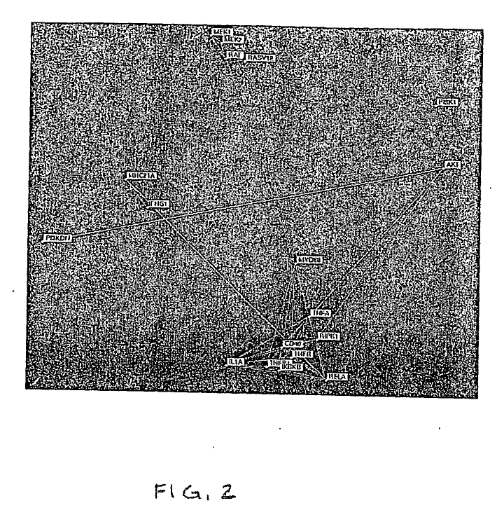

To create a centered “prediction envelope” requires the use of two sets of control replicates on each plate. These replicates provide a variability estimate for the combination of system and readout measurement on the given plate. Each set provides a point estimate for the parameter value. This point estimate can be obtained as the mean of the replicates, the median, etc. The overall mean of the two points is calculated and subtracted from the two point estimates thus centering the points around zero. Combining the points from all parameters of an experiment, one obtains a profile (symmetric lines around zero) representing an estimate of the control variability for the given experiment. Similar profiles from many experiments are used to create a “centered prediction envelope” using methodology identical to the one employed previously. A typical example of the construction of a control prediction envelope is presented in FIG. 2. This method can be further extended by using more than 2 sets of points per plate, for estimating the control variability. In this case, the three or more curves that provide the variability estimate will be centered by subtracting the overall mean curve, before adding them to the curves from other experiments for creating the “prediction envelope”.

An advantage of this approach is that by constructing envelopes based on curves that represent variability from a mean control value, the effect of the absolute OD value bias of each experiment is minimized.

“Centered prediction envelope” based on Hotteling's T2 method: This method is again using centered profiles of estimated variability transforming them into an equivalent single “distance” value. Centered profiles from multiple experiments are collected and the covariance matrix of the set is calculated. Then, forming the quadratic form of the profile vector and the covariance matrix we obtain a single numerical value that represents the “distance” of each control profile from the “center” of all control profiles. An empirical distribution of these distances, that represent the variability of the control profile across many experiments, is obtained. This distribution provides the means of predicting the expected variability of the control in a subsequent experiment at a predefined prediction level. This methodology has the additive advantage of accounting for the possible covariance of the readouts comprising the profile.

### Creation of “Trusted Profiles” Database

Due to the biological variability, a BioMAP® profile may vary from one experiment to another. In order to create a database of reference profiles; profiles are averaged from several repeats of an experimental system. The number of repeats that need to be averaged in order to obtain a “trusted” profile can be obtained through a classification process.

In one embodiment of the invention, the classification process for creating a trusted profile is as follows. An initial trusted profile is obtained by averaging N datasets of biomap profiles from N experiments, where the dataset may comprise a normalized biomap dataset as described above. The initial trusted profile should include representative samples of the functional space that needs to be covered.

For each initial trusted profile, the analysis will further include X number of datasets, which comprise similar experimental data to the initial trusted profile and which utilize the same experimental system, but which have not been included in the averaging process to generate the initial trusted profile. The X datasets are classified against the initial trusted profile using, a standard classification method, which may include, without limitation, k-nearest neighbors, neural networks, discriminant analysis, and the like. The classification error is plotted, e.g. as a function of the number of profiles that are used to obtain the average profile; number of well repeats; etc. The number of repeats required for minimizing the classification error is then established by visual inspection; mathematical criteria; etc. A trusted profile is then generated using the appropriate number of repeats that are required for minimizing classification error.

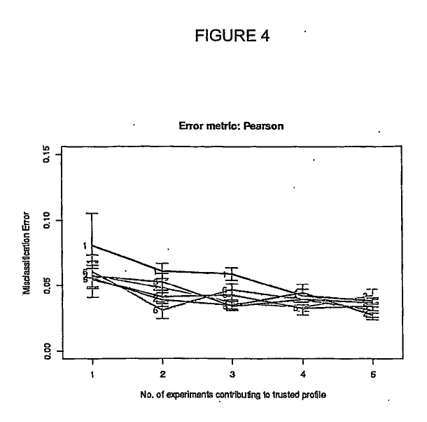

FIG. 4 presents such a graph. The error is given as a function of the number of profiles used for obtaining the “trusted” profiles (x-axis), as well as the number of wells used for each measurement (numbers on the curves). In this example, 3 repeats of the experimental profile are required to obtain a minimum in the classification error.

A feature of the invention is the generation of a database of profiles for a variety of agents, which agents may be compounds, genes, etc. Such a database will typically comprise trusted profiles as described above, for a number of agents. The agents of interest in a database may be selected and arranged according to various criteria: the types of molecules that are tested, e.g. steroids, antibiotics, neurotransmitters, etc.; by the source of compounds, e.g. environmental toxins, biologically active extracts from a particular animal or cell, etc.; by the effect of the compound on specific parameter outputs; by concentration or potency; and the like.

The trusted profiles and databases thereof may be provided in a variety of media to facilitate their use. “Media” refers to a manufacture that contains the datasets of the present invention. The datasets can be recorded on computer readable media, e.g. any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture comprising a recording of the present database information. “Recorded” refers to a process for storing information on computer readable medium, using any such methods as known in the art. Any convenient data storage structure may be chosen, based on the means used to access the stored information. A variety of data processor programs and formats can be used for storage, e.g. word processing text file, database format, etc.

As used herein, “a computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

### Identifying Significant Differences and Similarities

A test agent (gene, compound, biologic and/or combinations) profile is considered to be different than the control if at least one of the parameter values of the profile exceeds the “prediction envelope” limits that correspond to a predefined level of significance. The test for significance depends on the type of “prediction envelope” that is selected. For the non-centered “prediction envelope”, the test agent profile is compared against the envelope that has been calculated at the predefined significance level.

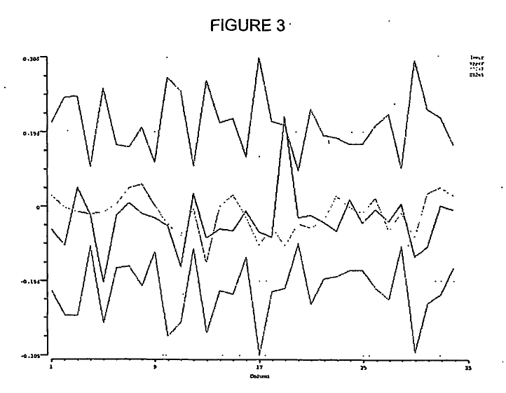

For the centered “prediction envelope” the ratio of the test agent profile to the control profile is formed by dividing the corresponding OD values of the agent and the control parameters. This operation is equivalent to centering the test agent profile in order to make it compatible with the centered envelope created at a predefined significance level (the normalization and transformation operations should be identical for consistency). It is suggested that the envelope be created using log transformed values and that the log of the ratio of the agent of the control profile be used. An example of such a test is presented in FIG. 3.

For the third method, the test agent profile is again centered by dividing with the corresponding control profile and the quadratic form of the centered profile and the covariance matrix of the controls is formed. The value obtained from this multiplication is then compared with the value obtained from the control variance distribution at the required significance level.

Similarity of profiles is used for establishing functional homology between a new test agent (compound, biologic, gene and/or combinations) and the profiles in the “trusted profiles” database.

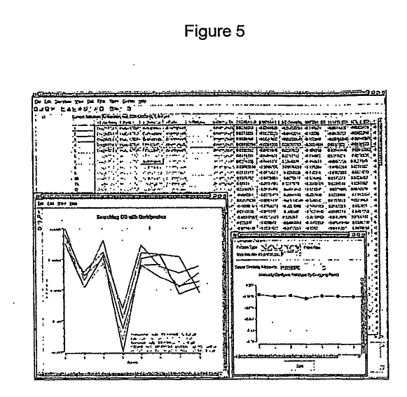

FIG. 5 shows a typical example where a search of the trusted profiles with the compound Flurbiprofen, provides a number of “hits” that are ordered by the degree of similarity (Pearson correlation) with the search profile. This search produces “hits”, the top five of which are known prostaglandin inhibitors (Flurbiprofen, budenoside, FR122047). However, while the correlation, e.g. Pearson, Euclidean, etc. provides an ordering of the potential functionally homologous candidates, it does not provide a way for the user to decide which of these similarities are significant and not due to chance.

To provide significance ordering, the false discovery rate (FDR) may be determined. First, a set of null distributions of dissimilarity values is generated. In one embodiment, the values of observed profiles are permuted to create a sequence of distributions of correlation coefficients obtained out of chance, thereby creating an appropriate set of null distributions of correlation coefficients (see Tusher et al (2001) PNAS 98, 5116-21, herein incorporated by reference). The set of null distribution is obtained by: permuting the values of each profile for all available profiles; calculating the pairwise correlation coefficients for all profile; calculating the probability density function of the correlation coefficients for this permutation; and repeating the procedure for N times, where N is a large number, usually 300. Using the N distributions, one calculates an appropriate measure (mean, median, etc.) of the count of correlation coefficient values that their values exceed the value (of similarity) that is obtained from the distribution of experimentally observed similarity values at given significance level.

The FDR is the ratio of the number of the expected falsely significant correlations (estimated from the correlations greater than this selected Pearson correlation in the set of randomized data) to the number of correlations greater than this selected Pearson correlation in the empirical data (significant correlations). This cut-off correlation value may be applied to the correlations between experimental profiles.

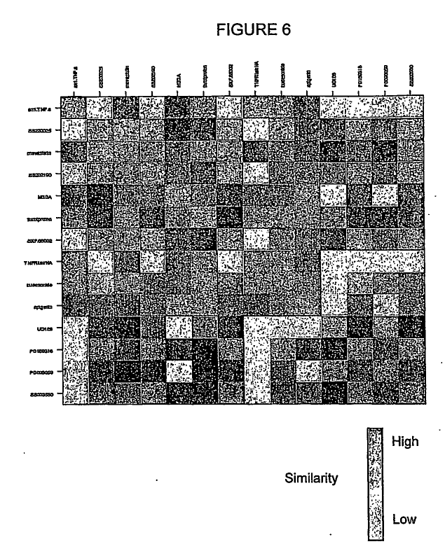

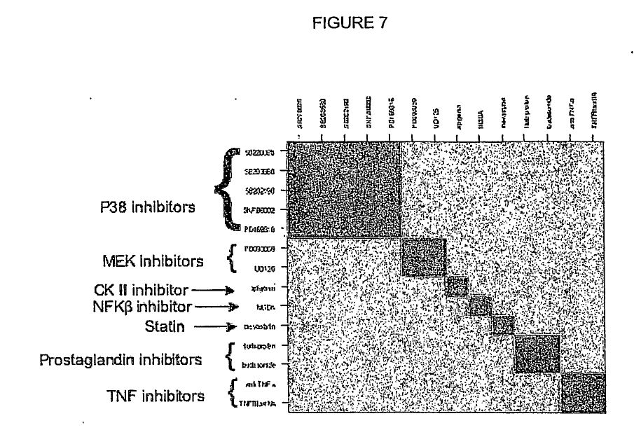

Using the aforementioned distribution, a level of confidence is chosen for significance. This is used to determine the lowest value of the correlation coefficient that exceeds the result that would have obtained by chance. Using this method, one obtains thresholds for positive correlation, negative correlation or both. Using this threshold(s), the user can filter the observed values of the pairwise correlation coefficients and eliminate those that do not exceed the threshold(s). Furthermore, an estimate of the false positive rate can be obtained for a given threshold. For each of the individual “random correlation” distributions, one can find how many observations fall outside the threshold range. This procedure provides a sequence of counts. The mean and the standard deviation of the sequence provide the average number of potential false positives and its standard deviation. FIGS. 6 and 7 show the results of applying this method to a set of compound profiles.

FIG. 6 presents the pairwise correlation matrix between the different compounds. It is obvious that it is very difficult to identify clusters of compounds that have similar profiles as well as which of these correlations are significantly different than the one obtained out of chance. FIG. 7 presents the same matrix after a threshold of significance of 0.995 has been applied to the data and a clustering algorithm has been applied to them.

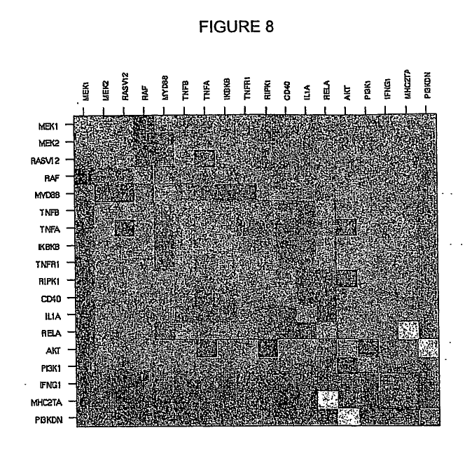

The same method may be applied to a set of gene data, for example as shown in FIG. 8. These pairwise correlation matrix were obtained using Pearson correlation between profiles that are the results of concatenating BioMAP profiles for four distinct systems (IL-1, TNF, IFN, 3C). The correlations have been thresholded using the similarity values that correspond to a 0.995 significance level. This approach proves to be very successful in clustering together those genes that are known to be members of the same pathway. The connectivity across pathways is established through only a few nodes, similarly to what have been observed experimentally.

### Clustering

The data may be subjected to non-supervised hierarchical clustering to reveal relationships among profiles. For example, hierarchical clustering may be performed, where the Pearson correlation is employed as the clustering metric. Clustering of the correlation matrix, e.g. using multidimensional scaling, enhances the visualization of functional homology similarities and dissimilarities. Multidimensional scaling (MDS) can be applied in one, two or three dimensions.

Application of 1D MDS produces a unique ordering for the agents, based on the distance of the agent profiles on a line. The rows and columns of the original matrix are then reordered to reflect the result of MDS. In the combination of multidimensional scaling and pivoting to move high correlations toward the diagonal: for each row, in the reordered pairwise correlation matrix, starting from the first and moving towards the last, is the rank of the correlation coefficients between the diagonal element and the last element on the row. The columns (and due to symmetry the rows) are then reordered so that the rank of the correlation coefficients is decreasing from the diagonal towards the limit of the matrix. These steps are repeated until all rows are processed. Once the connectivity of the nodes is established the results may be visually displayed for enhanced information accessibility to a user. In one embodiment, the results are displayed as a network.

However, hierarchical clustering with a binary comparison method can obscure significant similarities between compounds that are on different branches of a tree. This becomes particularly problematic as the number of variables (parameters and systems) increases. To allow objective evaluation of the significance of all relationships between compound activities, profile data from all multiple systems may be concatenated; and the multi-system data compared to each other by pairwise Pearson correlation. The relationships implied by these correlations may then be visualized by using multidimensional scaling to represent them in two or three dimensions.

In order to accomplish this, multidimensional scaling is used on the original profiles, transforming each one of them into a point in 2D or 3D space. The use of MDS for this operation is preferred because it preserves the relative distance of the nodes. Distances between agents are representative of their similarities and lines are drawn between compounds whose profiles are similar at a level not due to chance.

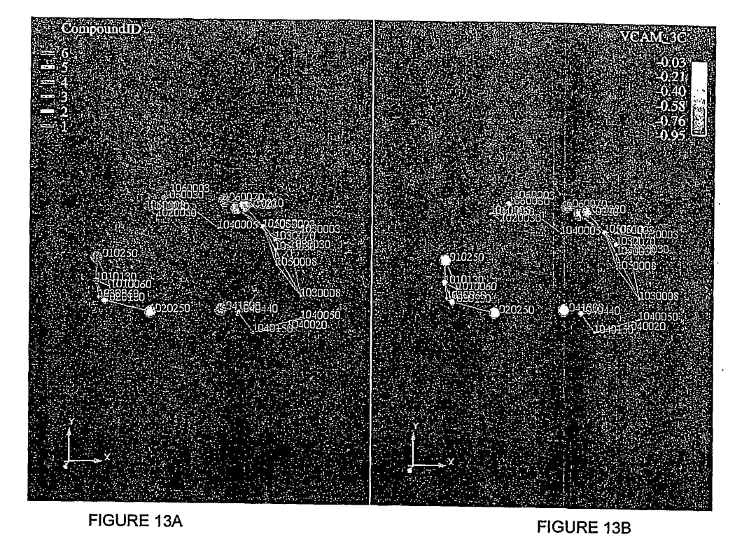

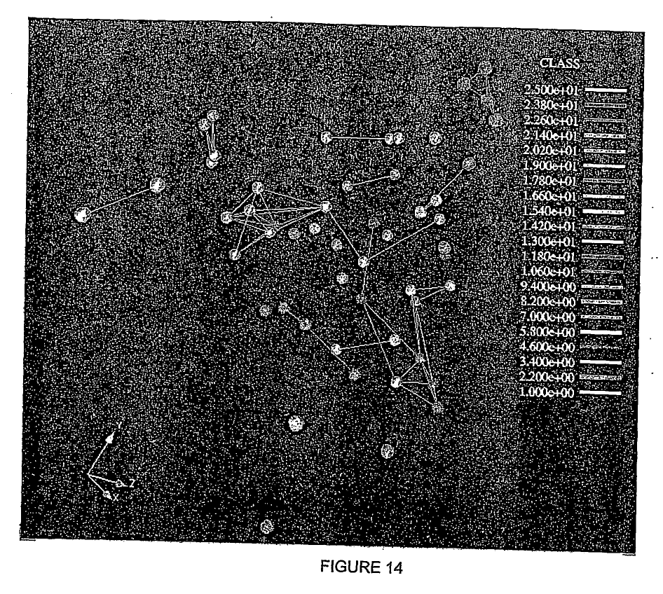

In addition to distance visualization, the display of information may include other classification schemes to aid in analysis. Each point, which represents a test agent in the comparison matrix, may be arbitrarily assigned features, such as color, size, shape, etc. where the assignment provides information about the agent. For example, the size of the point may represent the concentration of the agent used in the experimental analysis; or may convey the potency, e.g. IC50, of the agent. Colors and shapes may be used in various ways, e.g. to represent classes of compounds, such as steroids, lipids, polypeptides, polynucleotides, and the like; species of origin or gene families for natural compounds and genetic agents; signaling pathways in which the agent is known to be active; and the like. FIGS. 13 and 14 illustrate the use of features to display information.

Such additional information may also be conveyed by the use of multiple visualization windows. In addition to the graphic display of clustering information, the windows may contain text annotation of the profile; different spatial views of the matrix, different features, selected regions, and the like. FIGS. 13A and 13B illustrate two windows of the same statistical model.

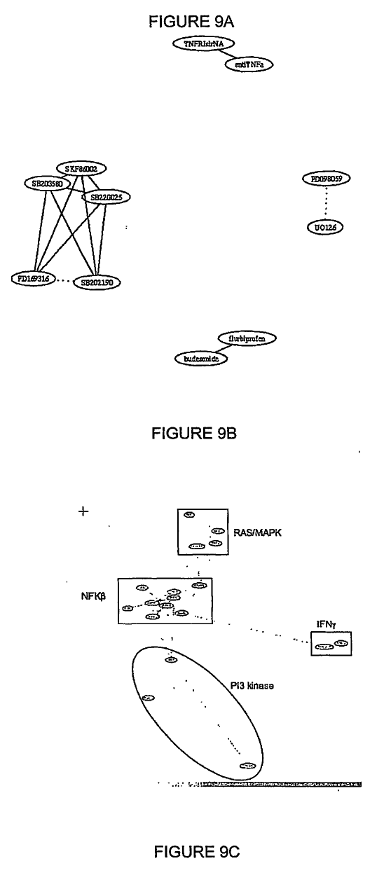

Three examples of this approach to compound and gene data are given in FIG. 9(a-c). FIG. 9a shows a 2D network for a compound set tested on a HuVEC-PBMC system (see FIG. 6). FIGS. 9(b-c) show the pathway interaction network for the genes involved in four pathways obtained through the application of the previous method to the composite BioMAP profile (4 systems).

The representation of a profile comparison in 3 dimensional space provides certain advantages, primarily in the improved ability to represent the distance between agents, where the distance represents the statistical correlation. The three-dimensional space may be displayed in one or more windows. Stereo visualization methods find use, e.g. where the user experience (especially depth perception of the network) is enhanced and better understanding of the interactions is possible. Stereo visualization requires a combination of software and hardware that can be readily obtained for today's workstations and visualization servers.

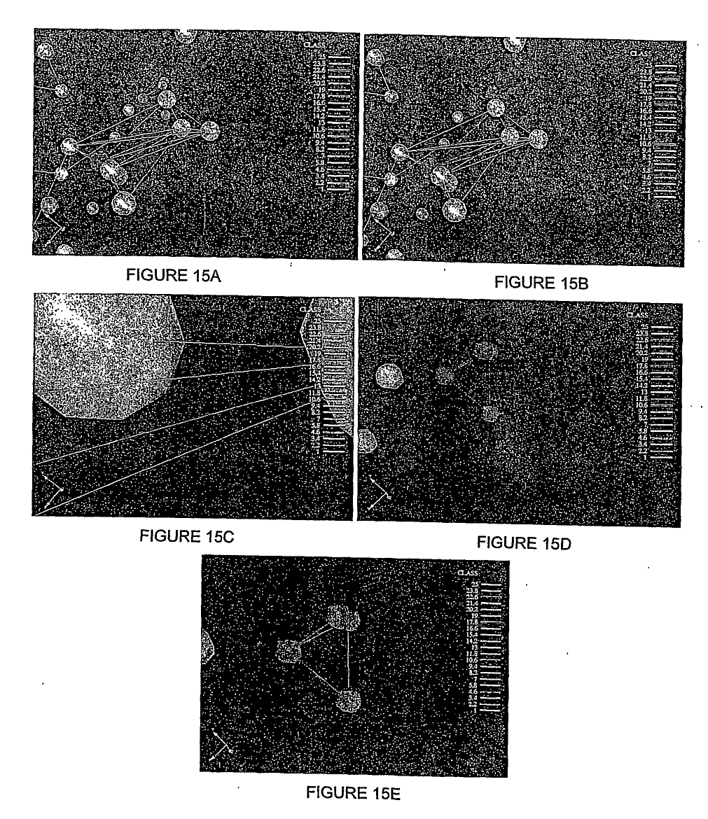

The distances between points are proportional to correlation distance, but over a large set of points, the solution is not optimized for every distance, and can create areas of less accuracy in the representation. To address this issue, the field of view may be restricted to a portion of the complete set, where the distances are optimized for those points currently visualized. As the field of view is moved through the 3 dimensional space, the distance may be recalculated in order to optimize for the new field of view. To provide for a smoother visualization impression, the recalculation may be performed in anticipation of the vector movement. The field of view may also comprise a filtering function, e.g. to convey a fading at the borders of the field; to screen out specific data points; and the like. The movement through space is shown in FIGS. 15A to 15E, where the point of view focuses on a specific subset of the space.

The functional homology analysis may be implemented in hardware or software, or a combination of both. In one embodiment of the invention, a machine-readable storage medium is provided, the medium comprising a data storage material encoded with machine readable data which, when using a machine programmed with instructions for using said data, is capable of displaying a any of the datasets and data comparisons of this invention. Such data may be used for a variety of purposes, such as drug discovery, analysis of interactions between cellular components, and the like. Preferably, the invention is implemented in computer programs executing on programmable computers, comprising a processor, a data storage system (including volatile and non-volatile memory and/or storage elements), at least one input device, and at least one output device. Program code is applied to input data to perform the functions described above and generate output information. The output information is applied to one or more output devices, in known fashion. The computer may be, for example, a personal computer, microcomputer, or workstation of conventional design.

Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage media or device (e.g., ROM or magnetic diskette) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

A variety of structural formats for the input and output means can be used to input and output the information in the computer-based systems of the present invention. One format for an output means test datasets possessing varying degrees of similarity to a trusted profile. Such presentation provides a skilled artisan with a ranking of similarities and identifies the degree of similarity contained in the test pattern.

It is to be understood that this invention is not limited to the particular methodology, protocols, cell lines, and reagents described, as such may vary. It is also to be understood that the terminology used herein is for the purpose of describing particular embodiments only, and is not intended to limit the scope of the present invention, which will be limited only by the appended claims.

As used herein the singular forms “a”, “and”, and “the” include plural referents unless the context clearly dictates otherwise. All technical and scientific terms used herein have the same meaning as commonly understood to one of ordinary skill in the art to which this invention belongs unless clearly indicated otherwise.

The examples are put forth so as to provide those of ordinary skill in the art with a complete disclosure and description of how to make and use the subject invention, and are not intended to limit the scope of what is regarded as the invention. Efforts have been made to ensure accuracy with respect to the numbers used (e.g. amounts, temperature, concentrations, etc.) but some experimental errors and deviations should be allowed for. Unless otherwise indicated, parts are parts by weight, molecular weight is average molecular weight, temperature is in degrees centigrade; and pressure is at or near atmospheric.

All publications mentioned herein are incorporated herein by reference for the purpose of describing and disclosing, for example, the compounds and methodologies that are described in the publications, which might be used in connection with the presently described invention. The publications discussed above and throughout the text are provided solely for their disclosure prior to the filing date of the present application. Nothing herein is to be construed as an admission that the inventors are not entitled to antedate such disclosure by virtue of prior invention.

### EXAMPLES

Despite extensive efforts to develop improved statistical techniques for predicting functional networks from large datasets the transition from whole-cell molecular measurements to useful models of cellular responses in higher eukaryotes remains daunting.

The techniques described here take advantage of several features. To reduce artifacts induced by the use of cell lines, primary human cells cultured in biologically relevant contexts were used; A small set of biologically relevant parameters were measured. And the same cell type was studied in multiple different contexts (culture conditions differing in cell activation stimuli), so as to allow functional characterization of a wide range of protein activities from a manageably small number of measurements.

To implement this approach, it is important to assemble a set of measurements and cell systems (cells in different defined contexts) broad enough to encompass most or all of the signaling pathways relevant to a particular biological process. The responses of these systems to genetic or other experimental perturbation is then registered by changes in the selected parameters. Here we show using vascular endothelium in 4 contexts defined by stimulation with different pro-inflammatory cytokines that BioMAP® analysis can predict functional relationships of proteins within pathways, and reveal interactions between different pathways that could not have been deduced from analysis of cells in any single context. BioMAP® analyses will be a useful tool for modeling of the signaling networks operating in human cells.

Methods

Cytokines, antibodies, and cell culture. Recombinant human IFN-γ, TNF-α, and IL-1βwere from R&D Systems, Murine IgG from Sigma, Mouse anti-human ICAM-1 (clone B4H10) from Beckman Coulter and mouse anti-human E-selectin (clone ENA1) from HyCult Biotechnology. Unconjugated mouse antibodies against human VCAM-1 (clone 51-10C9), CD31 (clone WM-59), HLA-DR (clone G46-6), MIG (clone B8-77), and MCP-1 (clone 5D3-F7) were from BD Biosciences. Mouse anti-human IL-8 (clone 6217.111) was from R&D Systems. PD098059 was from Calbiochem. EGM-2 medium and required supplements were from Clonetics. Human umbilical vein endothelial cells (HUVEC) were from Clonetics; cultured in microtiter plates in EGM-2 medium containing manufacturer's supplements plus 2% heat-inactivated fetal bovine serum. Confluent cell were stimulated with cytokines (1 ng/ml IL-1β, 5 ng/ml TNF-α, or 100 ng/ml IFN-γ) for 24 hours. PD098059 (3.7 μM final concentration) was added 1 hr before stimulation and was present during the whole 24 hr stimulation period.

Cell-based ELISAs. Cell-based ELISAs were carried out as previously described. Briefly, microtiter plates containing treated and stimulated HUVEC were blocked, and then incubated with primary antibodies or isotype control antibodies (0.01-0.5 μg/ml) for 1 hr. After washing, plates were then incubated with a peroxidase-conjugated anti-mouse IgG secondary antibody (Promega) for 1 hr. Plates were washed and developed with TMB substrate (Clinical Science Products) and the optical density (OD) was read at 450 nm (subtracting the background absorbance at 650 nm) on a SpectraMAX 190 plate reader (Molecular Devices).

Retroviral gene transduction. Test genes were cloned into a vector derived from the MoMLV-based vector pFB (Stratagene) downstream of the MoMLV LTR. A truncated form of the human nerve growth factor receptor (NGFR) preceded by an internal ribosomal entry site was used as a marker gene. Retroviral vector plasmid DNA was transfected into AmphoPack-293 cells (Clontech) by a modified calcium phosphate method according to the manufacturer's protocol (MBS transfection kit, Stratagene). Cell supernatants were harvested 48 hours post-transfection, filtered to remove cell debris (0.45 μm), and transferred onto exponentially growing HUVEC. DEAE dextran (10 μg/ml) was added to facilitate transduction. After 5-8 hr, the viral supernatant was removed and cells were cultured for an additional 40 hours. Gene transfer efficiency was determined by flow cytometric analysis using an NGFR-specific monoclonal antibody and was typically ≧70%.

Statistical analysis. The value of each parameter was measured three times per experiment, and two to four experiments were carried out for each over-expressed gene. Within each experiment, the mean value obtained for each parameter was then divided by the mean value from a sample transduced with empty vector to generate a ratio. All ratios were then log₁₀ transformed, and the transformed ratios averaged from repeat experiments, and non-parametric analysis was used to compare the profile of these ratios to the envelope of control profiles. Those profiles containing ratio values that exceeded the 95% prediction level envelope for control profiles were used to calculate pairwise Pearson correlation coefficients (Partek Pro version 5.1). To select statistically significant correlation coefficients, one hundred randomized datasets were created by permuting the original expression data, and the pairwise correlation coefficients were calculated for each randomized set. Correlation limits were then selected so as to exclude all but a defined minimal number of correlations from the randomized data sets. For the four cellular environments combined, limits of [−0.5035, 0.546] excluded all but 2.5% of the ‘correlations’ derived from the randomized datasets (in other words, at these limits 2.5% of the correlations observed are potentially false positives). Limits used to filter correlations obtained in individual cellular environments to the 2.5% false discovery rate were: IL-1β-treated cells [−0.87, 0.89]; TNF-α-treated cells [−0.87, 0.90], IFN-γ-treated cells [−0.86, 0.88]; and control cells [−0.84, 0.89].

TABLE 1
Genes over-expressed

| Gene | Gene description | GenBank no. |
|---|---|---|
| TNFRSF1A | TNF-α receptor type I | BC010140 |
| RIPK1 | Receptor-interacting | NM_003804 |
| | serine threonine kinase | |
| | 1 (RIP) | |
| TNFRSF5 | CD40 | BC012419 |
| TNFB | TNF-β (lymphotoxin A) | D12614 |
| TNFRSF10B | TRAIL receptor 2 | BC001281 |
| TNFA | TNF-α | NM_000594 |
| IKBKB* | I-κB kinase β (IKKB), | AF031416 |
| | constitutively | |
| | active¹⁵ | |
| RELA | NF-κB subunit | NM_021975 |
| | 3 (p65) | |
| IRAKI | IL-1 receptor-associated | BC014963 |
| | kinase 1 | |
| MGC3067 | Hypothetical protein | BC002457 |
| | MGC3067 | |
| MEK1* | MAP2K1, constitutively | NM_002755 |
| | active R4F¹⁶ | |
| MEK2* | MAP2K2, constitutively | L11285 |
| | active K71W¹⁶ | |
| RAF* | Raf1, constitutively | L00212 |
| | active¹⁷ | |
| RAS* | H-Ras, constitutively | NM_005343 |
| | active V12¹⁸ | |
| MYD88 | Myeloid differentiation | NM_002468 |
| | primary response gene 88 | |
| SHP2* | Phosphotyrosyl-protein | L03535 |
| | phosphatase (SH-PTP2), | |
| | dominant negative¹⁹ | |
| LSM1 | Sm-like protein 1 (CASM) | BC001767 |
| IFNG | IFN-γ | NM_000619 |
| MHC2TA | MHC class II transactivator | NM_000246 |
| | (C2TA) | |
| P2Y6R | Pyrimidinergic receptor | BC000571 |
| | P2Y | |
| TRADD | TNFR1-associated death | BC004491 |
| | domain protein | |
| IL11RA | IL-11 receptor α | BC003110 |
| AKT1* | AKT1-estrogen receptor | BC000479 |
| | fusion, constitutively | |
| | active upon tamoxifen | |
| | treatment²⁰ | |
| PI3K* | p110 subunit of pI3K, | M93252 |
| | constitutively active²¹ | |

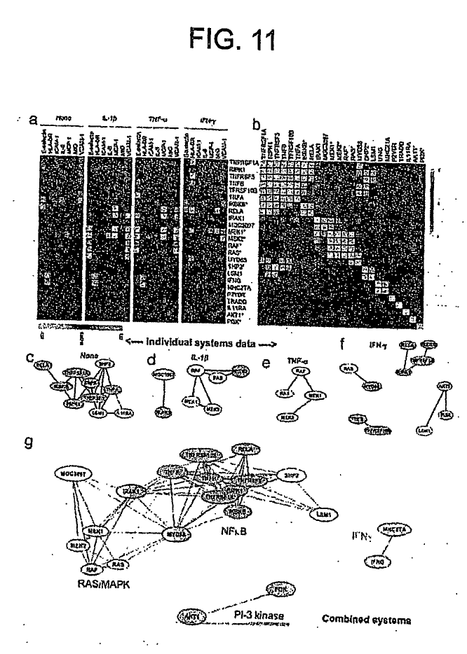

Significantly anti-correlated profiles were observed as well. The arrangement of genes in two dimensions was automatically determined from the entire set of correlation values by a multidimensional scaling method using AT&T GraphViz software; the statistically significant correlations are highlighted by connecting lines in FIG. 11c-g.

Results

Analysis of endothelial cells over-expressing signaling proteins. Endothelial cells control vascular inflammation by regulating leukocyte traffic and express immunomodulatory cytokines and chemokines. To analyze this range of activity, we over-expressed genes encoding key elements of the NF-κB signaling pathway, the PI3K/Akt pathway and the RAS/MAPK pathway in cultures of primary endothelial cells and stimulated individual pro-inflammatory pathways (listed in Table 1). Some genes (denoted by an asterisk) were over-expressed in a constitutively active form to maximize their activity. The effects were then assessed by measuring the levels of surface proteins known to be regulated by inflammation and/or to reflect the functional state of the cells, including VCAM-1, ICAM-1 and E-selectin (vascular adhesion molecules for leukocytes), HLA-DR (MHC class II; the protein responsible for antigen presentation), MIG/CXCL9 and IL-8/CXCL8 (chemokines that mediate selective leukocyte recruitment from the blood), and PECAM-1/CD31 (a protein controlling leukocyte transmigration).

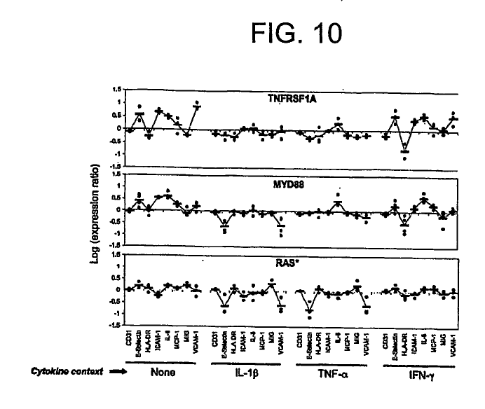

Genes to be over-expressed were introduced into endothelial cells by retroviral transduction. After waiting 48 hours to ensure that the encoded proteins were expressed, the cells were incubated for a further 24 hours in the presence of pro-inflammatory cytokines (IL-1β, TNF-α, or IFN-γ) or medium alone, and levels of readout proteins were measured by ELISA. FIGS. 10 and 11a show that the levels of readout proteins were a function of the gene being over-expressed and of the cell context (presence of pro-inflammatory cytokines). For example, TNFRSF1A (the gene encoding TNF receptor I) elicited strong responses in IFN-γ-treated and control cells, whereas RAS* (encoding a constitutively active form of RAS) was most active in the context of IL-1β- and TNF-α-treatment (FIG. 10). FIG. 11a summarizes the effect of each gene on the level of each readout protein in the four different cell systems (cells+contexts) employed.

Analysis of gene function by correlating responses. We next asked if the readout profiles could be used to identify functional relationships between the over-expressed genes. We initially performed pairwise comparisons of the readout profiles induced by all over-expressed genes in each individual cell system, measuring the similarity between profiles using Pearson correlation coefficients (r). The relationships implied by these correlations were visualized by using multidimensional scaling to represent them in two dimensions (FIG. 11c-f), drawing lines between pairs of genes whose profiles were significantly correlated.

Strikingly, the readout profiles of genes with closely related functions were indeed strongly correlated, but the strength of the correlation was highly dependent on the cell context. For example, the profiles produced by MEK1* and MEK2* were strongly correlated in IL-1β- and TNF-α-treated cells (r=0.95 and 0.98, respectively), but the correlation between the two did not survive significance filtering in IFN-γ-treated or control cells (r=0.69 and 0.68, respectively). Similarly, the profiles produced by TNFA and TNFB were highly correlated in control cells (r=0.98), but the correlations in IFN-γ-, IL-1β- and TNF-α-treated cells were not statistically significant (r=0.77, 0.68 and 0.74 respectively).

Context-dependent correlations were also seen between members of the same signaling pathway. For example, genes encoding members of the NF-κB pathway (including TNF-α, TNF-β, their receptor TNFRSF1A and the intracellular signaling molecules RIPK1, IKBKB*, and RELA) all produced correlated profiles in control cells and to lesser extent in IFN-γ-treated cells, but not in cells treated with IL-1β or TNF-α. By contrast, genes encoding members of the RAS/MAPK pathway (including RAS*, RAF*, MEK1*, and MEK2*) produced correlated profiles in IL-1β- and TNF-α-treated cells, but not in cells treated with IFN-γ or control cells. Thus, only some of the possible functional relationships can be mapped in any one cellular context. Conversely, some genes whose products are known to belong to the same signaling pathway (such as IRAK1 and MYD88, which both encode key components of the IL-1 signaling pathway, or IFNG, which induces the transcription of MHC2TA) did not produce significantly correlated responses in any of the individual cell systems tested.

Enhanced resolution of biological activity in correlations of combined profiles. Because the functional relationships observed depended so strongly on the cellular context, we hypothesized that an analysis that simultaneously encompasses the data from multiple context-defined systems should increase the sensitivity of our approach. We therefore concatenated the gene-induced readout profiles from the four cellular systems, yielding for each gene a combined profile comprising 28 normalized parameter readouts (the 7 measured parameters from each of the four systems: no cytokine, IL1, TNF, and IFN-γ treated endothelial cells). (As examples, the 28 parameter readouts illustrated inside the rectangles in FIG. 10 comprise the multi-system profiles for the TNF receptor, MYD88 or RAS*.) We performed pairwise comparisons of these 28-parameter profiles, measuring the similarity between profiles using Pearson correlations (summarized in FIG. 11b) and representing the implied relationships in two dimensions as before (FIG. 11g).

Virtually all the relationships observed in individual systems were still apparent, but many new relationships could also be detected, including those between IRAK1 and MYD88 and between IFNG and MHC2TA. The only relationships that were no longer evident were those previously detected between AKT1 and LSM1 in cells treated with IFN-γ and between IL11RA and TNFA or LSM1 in control cells. In fact, AKT1, LSM1 and IL11RA induced very different responses in other cellular contexts, indicating their distinct biological functions: the responses to AKT1 and LSM1 were generally related to those induced by PI3K and members of the NF-κB pathway, respectively, whereas IL11RA induced responses, especially robust in IL-1β- and TNF-α-treated cells, that were not significantly correlated to those produced by any other genes tested. Combining data obtained in multiple cell contexts thus improved the specificity as well as the sensitivity of the analysis.

Novel interactions between signaling pathways. One benefit of the greater detail revealed by multi-system BioMAP analysis was a much clearer separation of the genes whose products participate in different pathways. Genes encoding members of the NF-κB and RAS/MAPK pathways, for instance, define separate highly interconnected clusters in FIG. 11g. Even more strikingly, however, novel routes by which pathways can interact could also be detected. As shown in FIG. 11g, MYD88 and IRAK1 were functionally related to genes encoding members of both the NF-κB and RAS/MAPK pathways, suggesting that MYD88 and IRAK1 can interact with both of these pathways.

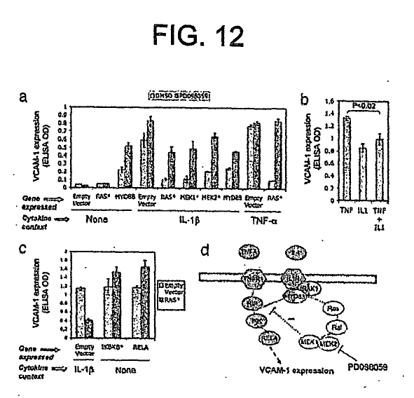

To explore this observation further, we re-examined the response to MYD88 and genes encoding representative members of the RAS/MAPK and NF-κB pathways (RAS* and TNFRSF1A, respectively) in all four cell systems. As shown in FIG. 10, over-expression of MYD88 and TNFRSF1A increased E-selectin, ICAM-1, IL-8 and VCAM-1 levels in IFN-γ-treated and control endothelial cells, consistent with the known ability of MYD88 and TNFRSF1A to activate the NF-κB pathway. By contrast, the response induced by MYD88 in IL-1β-treated cells was similar to that induced by RAS*, the main effect being to inhibit expression of the adhesion molecules VCAM-1 and E-selectin. Over-expression of MYD88 thus appears to stimulate the RAS/MAPK pathway under these conditions. Blocking the RAS/MAPK pathway by treatment with the MEK inhibitor PD098059 reversed the effect of MYD88 or RAS* over-expression (FIG. 12a), confirming that the effects induced by both genes were mediated by the RAS/MAPK pathway. MYD88 (and IRAK1) are known to be involved in IL-1-induced but not in TNF-induced signaling, and PD098059 indeed had no effect on VCAM-1 expression in TNF-α-treated cells (FIG. 12a). On the other hand, treating TNF-α-treated cells with low doses of IL-1β did reduce the level of VCAM-1 expression (FIG. 12b), as predicted from the effect of MYD88 in IL-1β-treated cells. The inhibitory effect of RAS* could be overcome by over-expressing RELA or IKBKB* (FIG. 12c), indicating that the interaction between the two pathways occurs upstream of IKBKB kinase. A schematic summary is presented in FIG. 12d. Multi-system analysis can thus detect novel functional interelationships between different signaling pathways.

Novel pathway participants and mechanisms. BioMAP analysis is also capable of identifying novel participants in signaling pathways and defining their network interactions. For example, the intracellular phosphatase SHP2 is known to have a role in growth factor-induced signaling. In our experiments, however, SHP2* showed clear functional similarity to members of the NF-κB pathway (FIG. 11g), reflecting for example a similar up-regulation of ICAM-1 and VCAM-1 in control cells, and down-regulation of HLA-DR in IFN-γ-treated cells), and demonstrating that this protein can regulate NF-κB signaling in endothelial cells. In fibroblasts, SHP2 has indeed been shown to interact physically with the NF-κB complex and is required for the NF-κB-dependent production of IL-6. Similarly, our studies reveal similarity of function of the hypothetical protein MGC3067 to IRAK1, MEK1 and MEK, leading to the testable hypothesis that it plays a role in the RAS/MAPK pathway.

Multi-system BioMAP analysis also revealed previously unidentified effects of known genes. TRADD, IL11RA and P2Y6R, for example, all induced unique profiles that were not significantly related to any known pathway. P2Y6R is a G-protein coupled receptor which binds uridine diphosphate (UDP). The precise relationship between this activity and the vascular responses to inflammation remain to be determined, but it is intriguing that P2Y6R also plays a role in monocyte responses to cytokine stimulation.

The BioMAP® technique we describe represents a simplification of existing approaches to systems biology. A very wide range of biological behavior can be examined by over-expressing signaling proteins in primary cells and evaluating the cells' responses in a range of biologically relevant environments. Surprisingly, only a small number of measurements from each perturbed cell state is required to reveal a great deal of information about the function of the perturbing gene product. Using this approach with endothelial cells in several contexts in which inflammatory signaling pathways are activated, we have rapidly reconstructed key pathway relationships of gene products, correctly identifying genes involved in several known inflammatory signaling pathways, and also revealing novel mediators of pathway interactions not previously known in endothelial cells. In addition, we have identified genes with unique activities in endothelial responses (e.g, P2Y6R, IL11RA) and others with activities similar to members of the NFκB or RAS pathways (SHP2 and MGC3067, respectively) leading to testable hypotheses about their pathway interactions. Thus BioMAP® analysis is useful for discovery and characterization of pathways and pathway interactions, and for defining key nodal and regulatory points in cell signaling networks.

The BioMAP® approach also allows analysis of signaling networks in other endothelial processes (e.g., angiogenesis) and in other cells types as well. Application to a given biology can utilize the empirical selection of systems (cell types and contexts) and parameters that provide a sufficient sensitivity and diversity of responses to perturbations of the physiologic processes being studied. In practice, these may be selected iteratively by evaluating different test sets of cell contexts and parameters for their ability to detect and discriminate benchmarking agents (e.g., select genes or functional proteins representing diverse relevant pathways). In the endothelial system we used here, the readout parameters were chosen to detect and discriminate signaling driven by three key cytokine drivers of the inflammatory process, IL-1β, TNF-α and IFN-γ that were also used to define three of the cell contexts studied. Nevertheless, this set of parameters also revealed the activity of other known signaling pathways (for example the RAS/MAPK and PI3K/Akt pathways) as well as that of newly identified pathways (such as signaling through the UDP receptor P2Y6R or the IL11 receptor).

This broad sensitivity may be an innate property of complex cellular systems, in which the level and state of each protein are actually an indirect reflection of the interactions between tens or hundreds of proteins. If We assume that we can experimentally identify both an appropriate set of readout parameters and a sufficient number of distinct contexts to capture the responses induced by over-expressing each gene, as few as 10 independent parameters would be sufficient to generate unique profiles for all human genes. (Assuming that there are 40,000 genes and that a readout parameter can have 3 states—up, down, or unchanged—allows 3¹⁰=59,049 profiles.) In practice, the breadth of pathway coverage and functional discrimination will depend on the cellular contexts and readout parameters selected.

These data clearly show that parallel interrogation of cells in multiple contexts allows classification of gene function using only a small set of readout parameters. From a theoretical perspective, it is clear that each gene product, and the network in which it participates, has evolved not to carry out a function in one particular cell context or environment, rather it has evolved to provide appropriate integration of inputs and outputs from any context the cell may encounter. Thus, the physiologic function of a gene product can only be defined by its effects within multiple cell contexts. The ability of BioMAP® analyses to efficiently classify gene function using only a few readouts shows that multi-system analyses contribute enormously to the biological information content. Indeed, multi-system analyses may be essential for modeling signaling networks from measurements of cell states no matter how many parameters are used.

In this study we used specific proteins as readouts, both because these proteins are directly relevant to the biology of vascular inflammation and because their levels can readily be measured in high-throughput assays, but other readouts such as transcript levels could certainly be used. Similarly, although the present example uses gene over-expression to perturb selected pathways, one may carry out a complementary analysis in which gene activity is suppressed using siRNA; or in which chemical compounds are assessed. Indeed, compound profiling using the BioMAP technique has recently been shown to be a powerful tool for characterizing potential drug candidates.

One of the findings in this study is the inhibition of the NF-κB pathway by IL1, MYD88, RAS and MEK in primary endothelial cells (FIG. 12d), suggesting that the RAS/MAPK pathway may help to prevent over-stimulation of the NF-κB pathway and expression of adhesion molecules in endothelial cells, so moderating immune responses and leukocyte recruitment. By contrast, RAS has been shown to activate the NF-κB pathway in transformed fibroblast and epithelial cell lines, suggesting that the same signaling molecule may have different biological roles in different cell types (or in transformed as opposed to primary cells).

The BioMAP® technique provides an independent system for classifying gene or compound function. It is well-suited to large-throughput analyses, and as such will allow a ‘discovery science’ approach to defining signaling networks in human cells. By providing critical insights into functional relationships and networks, BioMAP® analyses will accelerate the systematic reconstruction of signaling pathways in mammalian cells. The present invention, having been described in detail and illustrated by example above, will be understood by those of skill in the art, in light of the patent applications, patents; and scientific journal reference cited herein, all of which are incorporated herein by reference, to be embodied by the claims that follow.

What is claimed is:

1. A method of determining the functional homology between two agents, the method comprising:
deriving a biological dataset profile comprising output from 2 or more parameters, from an experimental system for a test agent;
generating a prediction envelope from a control biological dataset profile, which prediction envelope provides upper and lower limits for experimental variation;
wherein a test agent profile is considered to be different than the control if at least one parameter value of the profile exceeds the prediction envelope limits that correspond to a predefined level of significance.

2. The method according to claim 1, wherein said test agent is a genetic agent.

3. The method according to claim 1, wherein said agent is a chemical or biological agent.

4. The method according to claim 1, wherein said biological dataset profile comprises readouts from multiple cellular parameters resulting from exposure of cells to biological factors in the absence or presence of a test agent.

5. The method according to claim 4, wherein said system comprises a plurality of samples of a single cell type or types in a common biologically relevant context; comprising at least one control in the absence of the test agent.

6. The method according to claim 5, wherein a plurality of systems are concatenated for simultaneous analysis.

7. The method according to claim 6, further comprising the step of displaying relationships between two or more agents after non-supervised hierarchical clustering.

8. The method according to claim 1, wherein said biological dataset profile from an experimental system for a test agent; and said control biological dataset profile are normalized by the method comprising:
obtaining a mean value for each parameter;
dividing the mean parameter value by the mean parameter value from a negative control sample to generate a ratio;
transforming said ratio.

9. The method according to claim 8, wherein said control prediction envelope is non-centered, and generated by the method comprising:
creating a 1-standard deviation envelope around the profile of the combined means for each measured values for parameters;
moving the envelope lines in a parallel fashion outwards until a predetermined number of control profiles are completely contained within the envelope lines; and a user specified number has at least one of the measured parameters outside the envelope lines.

10. The method according to claim 8, wherein said control prediction envelope is centered, and generated by the method comprising:
determining the mean from two control point estimates;
subtracting the mean from the two control point estimates to center the points;
combining the points from all parameters of a system to obtain centered profiles.

11. The method according to claim 10, wherein said control prediction envelope further comprises a third control curve.

12. The method according to claim 10, wherein said control prediction envelope is centered, and generated by the method comprising:
calculating a covariance matrix of a set of centered profile
forming a quadratic form of profile vector and the covariance matrix to obtain a single numerical value that represents the distance of each control profile from the center of all control profiles.

13. The method according to claim 8, wherein normalized test agent profiles are used to generate a trusted profile, the method comprising:
obtaining an initial trusted profile by averaging N datasets of profiles from N experiments;
classifying X number of datasets that utilize the same experimental system, but which have not been included in the averaging process to generate the initial trusted profile;
plotting the classification error;
establishing a value for N that minimizes classification error;
generating a trusted profile using said value of N that minimizes classification error.

14. The method according to claim 8, further comprising the step of determining the false discovery rate, by the method comprising:
generating a set of null distributions of dissimilarity values.

15. The method according to claim 14, wherein said generating a set of null distributions comprises:
permuting the values of each profile for all available profiles;
calculating the pairwise correlation coefficients for all profiles;
calculating the probability density function of the correlation coefficients for this permutation; and repeating the procedure for N times; and
using N null distributions to calculate a measure of the count of correlation coefficient values whose values exceed the value obtained from the experimentally observed distribution for given significance level.

16. The method according to claim 7, wherein a Pearson correlation is employed as the clustering metric.

17. The method according to claim 16, wherein multidimensional scaling is applied in one, two or three dimensions.

18. The method according to claim 17, wherein a combination of multidimensional scaling and pivoting is used to move high correlations toward the diagonal

19. The method according to claim 18, wherein the results of said multidimensional scaling and pivoting are displayed as a network.

20. The method according to claim 19, wherein the display of information further comprises other classification schemes to aid in analysis.

21. The method according to claim 20, wherein additional information is conveyed by the use of multiple visualization windows.

22. The method according to claim 21, wherein additional information is conveyed by the use of stereo visualization.

23. The method according to claim 19, where the field of view of said display is restricted to a portion of the complete set, and where distances are optimized for those points currently visualized.

24. A system for the determining the functional homology between two agents, the system comprising:
a data processor comprising software for determination of functional homology between two agents by the algorithm comprising:
deriving a biological dataset profile from an experimental system for a test agent;
generating a prediction envelope from a control biological dataset profile, which prediction envelope provides upper and lower limits for experimental variation;
wherein a test agent profile is considered to be different than the control if at least one parameter value of the profile exceeds the prediction envelope limits that correspond to a predefined level of significance.
